(19) United States
(12) Patent Application Publication
(10) Pub. No.: US 2009/0119943 A1
(43) Pub. Date: May 14, 2009

(54) Vented dryer with heat recovery and condensate pan and method for operation thereof

(75) Inventors: Klaus Grunert, Berlin (DE); Guenter Steffens, Dallgow-Doeberitz (DE); Andreas Stolze, Falkensee (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch und Siemens Hausgeraete GmbH, Muenchen (DE)

(21) Appl. No.: 12/290,485

(22) Filed: Oct. 30, 2008

(30) Foreign Application Priority Data
Oct. 31, 2007 (DE) 10 2007 052 079.6

(51) Int. Cl. F26B 3/00; F26B 19/00; F26B 25/06

(52) U.S. Cl. 34/513; 34/86; 34/235

(57) ABSTRACT

The invention relates to a vented dryer having a drying chamber for items to be dried, a supply air duct for supply air, in which is situated a heater for heating the supply air and the heated supply air (process air) can be directed by means of a first fan over the items to be dried, an exhaust air duct, a motor for driving the drying chamber, a first heat exchanger in the exhaust air duct and a condensate pan arranged beneath the first heat exchanger, whereby the vented dryer has first means for the discharge of warm air from a housing interior surrounding the motor toward the condensate pan and away across the latter. The invention also relates to a method for the operation of this vented dryer.

### BACKGROUND OF THE INVENTION

The invention relates to a vented dryer with heat recovery and condensate pan and also a preferred method for operation thereof.

### SUMMARY OF THE INVENTION

In general, tumble dryers are operated as vented or condensation dryers. Condensation dryers, whose mode of operation is based on the condensation of the moisture evaporated from the washing by means of warm process air, require no exhaust air hose and enable energy to be recovered from the heated process air, through the use of a heat pump for example. However, it is in general necessary in the case of condensation dryers to collect the condensate occurring and either to pump it away or to dispose of it by manually emptying collecting vessels.

With regard to vented dryers on the other hand, in general the air charged with moisture after passing through a washing drum is discharged from the dryer, whereby no heat recovery takes place. Vented dryers with heat recovery are known, however.

DE 30 00 865 A1 discloses a tumble dryer with heat recovery. The tumble dryer consists of a container holding and moving the washing, into which flows a supply air flow heated by a heating element, while the moist warm air is directed as exhaust air by way of an outlet. In the supply air flow, a heat exchanger through which the moist hot exhaust air from the container is passed, is arranged upstream of the heating element.

A tumble dryer with a heat pump circuit is described in DE 40 23 000 C2, in which a supply air opening which can be closed with a controllable closure device is arranged in the process air duct between the condenser and the evaporator.

With regard to vented dryers with heat recovery, ambient air (for example at 20° C. and 60% relative humidity; so-called supply air) normally flows into the heat exchanger surfaces of an air-to-air heat exchanger and is heated up there whilst cooling the warm process air coming from the drying chamber. Depending on the cooling efficiency, or the heat exchange, condensate is produced which is collected in a container (condensate pan) or is pumped away. In the former case emptying is required and in the latter case a connection to the waste water system is required. The quantity of condensate occurring is a measure of the heat energy given off in the heat exchanger and thus a measure of the improvement in energy efficiency.

The object of the present invention was to provide a vented dryer with high energy efficiency, where it is not necessary to pump away condensate which is produced or to empty a condensate pan.

This object is achieved according to the invention by a vented dryer having the features described in claim 1 and by the method described in claim 12.

Preferred embodiments of the vented dryer according to the invention are set down in subclaims 2 to 11. A preferred embodiment of the method according to the invention is set down in claim 13.

The invention thus relates to a vented dryer having a drying chamber for items to be dried, a supply air duct for process air, in which is situated a heater for heating the supply air and the heated supply air (process air) can be directed by means of a first fan over the items to be dried, an exhaust air duct, a motor for driving the drying chamber, a first heat exchanger in the exhaust air duct and a condensate pan arranged beneath the first heat exchanger, whereby the vented dryer has first means for the discharge of warm air from a housing interior surrounding the motor toward the condensate pan and away across the latter.

With regard to the heater for heating the exhaust air (process air), this can for example be an electrical resistance heating facility and/or a second heat exchanger. By preference, both an electrical resistance heating facility and a second heat exchanger are used. With regard to the second heat exchanger, this can be an air-to-air heat exchanger, in which the warm air from the drying chamber is used for heating the process air, or the condenser of a heat pump. In this situation, the supply air duct and the exhaust air duct carrying the warm air from the drying chamber or the condenser of the heat pump having the heated cooling agent generally cross one another.

In a preferred embodiment of the invention, between the first heat exchanger and an exhaust air exit the exhaust air duct has an opening which on account of a suction effect, produced as a result of exhaust air flowing across the opening (Venturi effect), enables air situated above the condensate pan to be carried away (or “expelled”). The opening is preferably situated above the condensate pan.

In a further preferred embodiment, the aforementioned first means comprise a second fan (can also be referred to as “evaporation fan”) which conveys the warm air from a housing interior surrounding the motor toward the condensate pan and away across the latter. In this situation, it is again preferred for the first fan and the second fan to be driven by the same motor. By particular preference in this situation, the first fan and the second fan are arranged on opposite sides of the motor. By particular preference, the motor in question is the motor which is also used for driving the drying chamber.

Both aforementioned embodiments can be combined in such a manner that the discharge of the warm air toward the condensate pan and away across the latter is brought about as a result of interaction of the suction occurring at the opening in the exhaust air duct and the second fan.

With regard to the aforementioned primary means, this is a case for example of a configuration of the housing interior and also the air ways in the area of the motor and also the feed from the housing interior to the condensate pan, which enables an effective evacuation of the waste heat, and also finally the means enabling the discharge of the warm air such as for example a second fan and/or a hole in the exhaust air duct between exhaust air exit and first heat exchanger. The aforementioned first means are preferably chosen such that they enable the discharge of warm air at a rate of 10 to 100 m³/hour.

The dryer according to the invention has at least one first heat exchanger, by means of which the heat contained in the exhaust air is recovered upon the incidence of condensate in the condensate pan.

In this situation, this can be an air-to-air heat exchanger in which the moist hot process air from the drying chamber (drum) is used for heating supply air which is then delivered to the drying chamber.

Alternatively or in addition, an evaporator of a heat pump circuit can be used as a first heat exchanger. In the case of a dryer equipped with a heat pump the cooling of the warm process air charged with moisture essentially takes place in the evaporator of the heat pump where the transferred heat is used in order to evaporate a cooling agent used in the heat pump circuit. The cooling agent of the heat pump evaporated by virtue of the heating is delivered by way of a compressor to the condenser of the heat pump, where heat which is used for heating up the supply air before it enters the drying chamber (drum) is released by virtue of the condensation of the gaseous cooling agent.

In preferred embodiments of the dryer according to the invention having a heat pump the condenser of the heat pump is situated in the supply air duct between the first fan and the heater or between the first fan and the supply air inlet.

It is also possible to use a plurality of heat exchangers, at each of which condensate can form. In such a case it is also possible to use more than one condensate pan.

The condensate pan is preferably designed such that it can contain an adequate quantity of condensate, in general at least 0.5 l. The quantity of condensate occurring and thus the predefined holding capacity of the condensate pan for condensate will depend as a rule on the degree of efficiency of the first heat exchanger. However, given a loading capacity of 5 kg of washing at 60% relative humidity for the vented dryer a holding capacity of at least 0.5 l will generally be required.

According to the invention, the condensate pan preferably has second means for the detection and/or discharge of a quantity of condensate exceeding a predefined limit quantity. For example, a second container can be provided which can collect any overflowing condensate. Alternatively or in addition to this an audible or visual warning indication can occur when the limit quantity is reached.

In a preferred embodiment of the present invention a body with a high surface is present in the condensate pan. This body is preferably a fleece.

The evaporation of the condensate takes place in general particularly effectively at the beginning and also toward the end of a drying process since in both cases the charging of the process air with moisture is relatively low.

For the case where a residual quantity of condensate (liquid water) should remain in the condensate pan on completion of a drying process, the dryer according to the invention is preferably designed such that this remaining condensate evaporates while the dryer is cooling. This can happen for example in the case of the embodiment having an opening between the exhaust air exit and the first heat exchanger by virtue of the fact that given the presence of an external exhaust air pipe—particularly in windy weather—a slight air current is also produced in the area of the condensate pan.

It is inventively preferred if exhaust air and supply air and/or cooling agent in the heat pump are directed in each case through the corresponding heat exchangers using a cross-current or counter-current method.

Since the energy requirement for the drying operation reduces with the advancing degree of dryness of the items to be dried in the vented dryer, the heater is advantageously regulated accordingly, in other words its heating output is reduced with the advancing degree of dryness.

The invention furthermore relates to a method for the operation of a vented dryer having a drying chamber for items to be dried, a supply air duct for process air, in which is situated a heater for heating the supply air and the heated supply air (process air) can be directed by means of a first fan over the items to be dried, an exhaust air duct, a motor for driving the drying chamber, a first heat exchanger in the exhaust air duct, a condensate pan arranged beneath the first heat exchanger and first means for the discharge of warm air from a housing interior surrounding the motor toward the condensate pan and away across the latter, whereby condensate accumulating in the condensate pan during operation of the vented dryer is evaporated by means of warm air which is directed from the housing interior surrounding the motor toward the condensate pan and away across the latter, and the warm moist air resulting in this situation is expelled from the vented dryer.

In a preferred embodiment of the method a second fan directs the warm air from the housing interior surrounding the motor toward the condensate pan and away across the latter.

The warm and moist air conveyed away across the condensate pan can be either expelled directly into the space where the dryer is set up or can be mixed with the exhaust air from the dryer.

The vented dryer according to the invention and the method according to the invention for its operation have the advantage that the vented dryer falls into a better energy efficiency class and accumulating condensate can be conveyed to the outside simply through discharge by means of exhaust air without the need for a condensate pan requiring emptying or for a pump. Furthermore, the invention has the advantage that the waste heat from the motor is discharged according to the invention. On account of the active cooling of the motor, this can be designed to be smaller in respect of its laminated core and winding.

### BRIEF DESCRIPTION OF THE DRAWINGS

Further details of the invention will result with reference to FIGS. 1 to 3 from the description which follows of non-restrictive examples of the vented dryer according to the invention and the method for operation of said vented dryer.

FIG. 1 shows a vertical section of a vented dryer (“dryer” for short in the following) according to an embodiment of the invention in which both an opening in the exhaust air duct between exhaust air exit and first heat exchanger and also a second fan are used for conveying the warm air from a housing interior toward the condensate pan.

FIG. 2 shows a section from one embodiment of a vented dryer according to the invention.

FIG. 3 shows a section from a further embodiment of a vented dryer according to the invention.

### DETAILED DESCRIPTION OF EXEMPLARY EMBODIMENTS OF THE PRESENT INVENTION

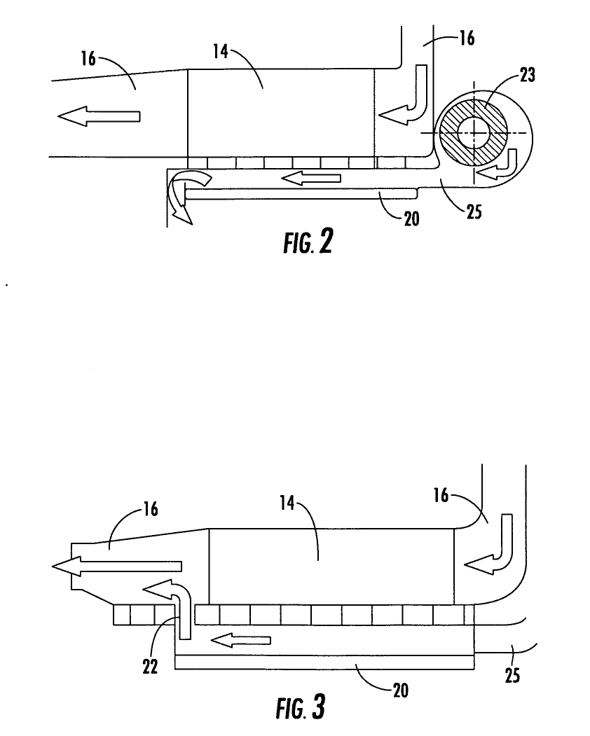

In FIGS. 2 and 3 the large arrows indicate the flow direction of the exhaust air while the small arrows indicate the flow direction of the warm air coming from the housing interior and conveyed across the condensate pan.

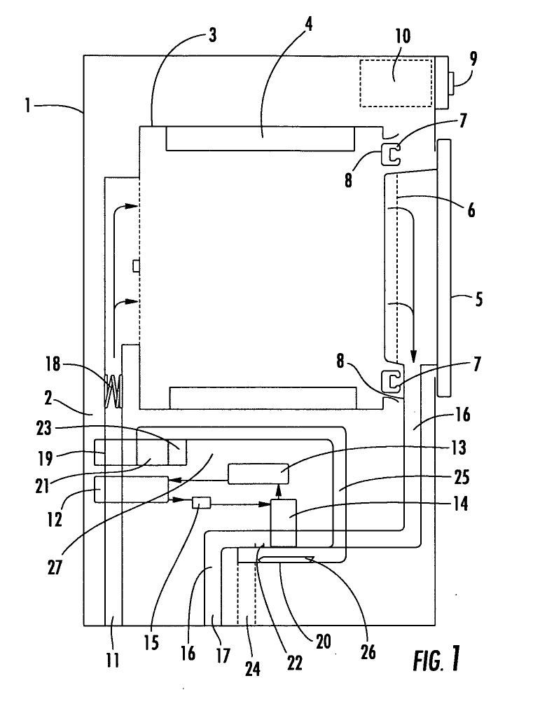

The dryer 1 illustrated in FIG. 1 has a drum capable of rotation around a horizontal axis as its drying chamber 3, inside which are secured paddles 4 for moving washing while the drum is rotating. Supply air is passed through the drum 3 by means of a first fan 19 from the supply air inlet 11 through a supply air duct 2 by way of a condenser 12 of a heat pump 12,13,14,15 as a second heat exchanger and a heater 18. After exiting the drum 3, the process air charged with moisture is directed as exhaust air onward through an exhaust air duct 16 by way of an evaporator 14 of a heat pump 12,13,14,15 and an exhaust air exit 17 into the space where the dryer 1 is set up. At this juncture, after passing through the drum 3, the moist warm process air is cooled and after condensation of the moisture contained in the process air is conveyed as exhaust air into the space where the dryer is set up. In this situation, air heated by the heater 18 is introduced from the rear, in other words from the side of the drum 3 lying opposite a door 5, into the drum 3 through the latter's perforated base, where it comes into contact with the washing to be dried and flows through the filling opening of the drum 3 to a fluff sieve 6 inside a door 5 closing the filling opening. The air flow is subsequently deflected downward in the door 5 and conveyed by the exhaust air duct 16 to the evaporator 14 of the heat pump 12,13,14,15. As a result of cooling, the moisture taken up by the process air from the items of washing condenses there and is collected in a condensate pan 20. The cooled and dehumidified process air exits the exhaust air duct 16 as exhaust air at the exhaust air exit 17.

With this embodiment, a warm air flow originating from the surroundings of a motor 21 for driving the drum 3 and the first fan 19 is passed over the condensate accumulated in the condensate pan 20 by way of a feed 25. As a result, the condensate evaporates and is carried away by the warm, now moist air flow. The conveyance of the warm moist air flow takes place in the case of the embodiment illustrated in FIG. 1 through an opening 22 in the exhaust air duct 16, which is situated in the area of the condensate pan, preferably above the condensate pan. The opening 22 connects the gaseous phase above the condensate pan with the exhaust air in the exhaust air duct 16 of the vented dryer. As a result of exhaust air flowing across the opening 22 a suction is produced (Venturi effect) which leads to the warm moist air above the located condensate being carried away. In the embodiment shown in FIG. 1 the warm air flow is conveyed from the surroundings of the motor 21 with the aid of a second fan 23 (“evaporation fan”) through the feed 25 across the condensate accumulated in the condensate pan 20. It is however also possible to dispense with the second fan 23 or the opening 22. If the opening 22 is dispensed with, the warm moist air caused by the evaporation of the condensate can be conveyed by way of a separate duct 24, drawn in dashed lines in FIG. 1, into the space where the dryer is set up. Also conceivable is a combination of the warm air charged with condensate with the exhaust air in the exhaust air duct 16 at a point closer to the exhaust air exit 17. Here, “point closer” means that the combination takes place in the exhaust air duct downstream of the point at which, where applicable, an opening for the generation of a suction effect could be provided.

The moist warm process air is conveyed to the evaporator 14 of a heat pump 12,13,14,15 where it is cooled. The cooling agent of the heat pump evaporated in this situation in the evaporator 14 is conveyed by way of a compressor 13 to the condenser 12. In the condenser 12 the cooling agent condenses whilst dissipating heat to the supply air entering through the supply air inlet 11 in the supply air duct 2. The cooling agent now present in liquid form is then conveyed by way of a flow control valve 15 to the evaporator 14, as a result of which the cooling agent circuit is closed.

In the embodiment shown in FIG. 1 the drum 3 is mounted at the rear base by means of a swivel bearing and at the front by means of a bearing bracket 7, whereby the drum 3 is supported with a flange on a glide strip 8 on the bearing bracket 7 and is thus held at the front end. Control of the vented dryer is exercised by way of a control facility 10 which can be regulated by the user by way of an operating unit 9.

With regard to the embodiment shown in FIG. 1 the first fan 19, the second fan 23 and also the drum 3 are driven by the same motor 21, whereby the first fan 19 and the second fan 23 are situated on opposite sides of the motor 21.

With regard to the embodiment shown in FIG. 1 a body 26 with a large surface, preferably a fleece, is situated in the condensate pan 20. The body 26 has the function of supporting evaporation of the condensate by distributing it over a large surface.

FIG. 2 shows a section from a further embodiment of a vented dryer according to the invention. In this embodiment, warm air is conveyed from the housing interior, in particular the surroundings of the motor 21, not shown here, by means of a second fan 23 (“evaporation fan”) in a feed 25 to the condensate pan 20 in which the condensate occurring at the first heat exchanger 14 is collected. The condensate can evaporate easily on account of the warm air flow. The evaporated condensate is carried away by the warm air flow and can—not shown in detail in FIG. 2—either be discharged directly into the space where the vented dryer is set up or can be mixed with the exhaust air from the dryer in the exhaust air duct 16.

FIG. 3 shows a section from a further embodiment of a vented dryer according to the invention. In this embodiment, the warm air from the surroundings of the motor 21, not shown here, is conveyed in a feed 25 as a result of the suction effect across the condensate contained in a condensate pan 20, produced at an opening 22 in the exhaust air duct 16 without the aid of a second fan. The air containing evaporated condensate is conveyed together with the exhaust air into the space where the vented dryer is set up. In FIG. 3, 14 means a first heat exchanger.

The embodiments illustrated in FIGS. 2 and 3 can also be combined, as is shown for example in FIG. 1.

1. A vented dryer, comprising
a drying chamber for items to be dried;
a supply air duct for supply air, in which is situated a heater for heating the supply air;
a first fan that directs a heated supply air over the items to be dried;
an exhaust air duct;
a motor for driving the drying chamber,
a first heat exchanger in the exhaust air duct;
a condensate pan arranged beneath the first heat exchanger; and
a means for discharging warm air from a housing interior surrounding the motor toward the condensate pan and away across the latter.

2. The vented of claim 1, wherein the exhaust air duct has an opening between the heat exchanger and an exhaust air exit which enables air above the condensate pan to be carried away on account of a suction effect.

3. The vented dryer of claim 1, wherein the means comprises a second fan that conveys the warm air from a housing interior surrounding the motor toward the condensate pan and away across the latter.

4. The vented dryer of claim 3, wherein the first fan and the second fan are driven by the motor.

5. The vented dryer of claim 4, wherein the first fan and the second fan are on opposite sides of the motor.

6. The vented dryer of claim 1, further comprising a body having a large surface in the condensate pan.

7. The vented dryer of claim 6, wherein the body comprises a fleece.

8. The vented dryer of claim 1, wherein means enable the discharge of warm air at a rate of 10 to 100 m³/hour.

9. The vented dryer of claim 1, wherein the first heat exchanger comprises an evaporator of a heat pump circuit.

10. The vented dryer of claim 1, wherein the first heat exchanger comprises an air-to-air heat exchanger.

11. The vented dryer of claim 1, wherein the condensate pan comprises a second means for the detection and/or discharge of a quantity of condensate exceeding a predefined limit quantity.

12. A method for operating a vented dryer having a drying chamber for items to be dried, a supply air duct for process air, in which is situated a heater for heating the supply air and the heated supply air can be directed by means of a first fan over the items to be dried, an exhaust air duct, a motor for driving the drying chamber, a first heat exchanger in the exhaust air duct, a condensate pan arranged beneath the first heat exchanger and first means for discharging warm air from a housing interior surrounding the motor toward the condensate pan and away across the latter, the method comprising:
evaporating condensate accumulating in the condensate pan by means of warm air, which is directed from the housing interior surrounding the motor toward the condensate pan and away across the latter, to provide warm moist air; and
expelling the warm moist air from the vented dryer.

13. The method of claim 12, further comprising directing warm air from the housing interior surrounding the motor toward the condensate pan and away across the latter with a second fan.
